(19) United States
(12) Patent Application Publication
(10) Pub. No.: US 2005/0191055 A1
(43) Pub. Date: Sep. 1, 2005

(54) Arrayed wavelength converter

(75) Inventors: Shinji Maruyama, Yokohama (JP); Rumiko Matsuda, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/872,558

(22) Filed: Jun. 22, 2004

(30) Foreign Application Priority Data
Feb. 27, 2004 (JP) 2004-054926

(51) Int. Cl. H04J 14/00

(52) U.S. Cl. 398/45

(57) ABSTRACT

An arrayed wavelength converter comprises a demultiplexing section that demultiplexes an input WDM signal light to output the demultiplexed lights, and a multiple wavelength conversion waveguide array in which the optical signals of respective wavelengths output from the demultiplexing section are given respectively to a plurality of waveguides formed in parallel on a substrate made of ferroelectric crystal. The multiple wavelength conversion waveguide array has a periodic polarization structure formed by periodically providing polarization inversion regions in which a polarization direction of the substrate is inversed, in a direction approximately perpendicular to a traveling direction of lights being propagated along the respective waveguides, and this is set such that a period of the periodic polarization structure is made different for each waveguide. As a result, it becomes possible to perform wavelength conversion of a plurality of optical signals at high efficiency with a simple structure.

### BACKGROUND OF THE INVENTION

(1) Field of the Invention

The present invention relates to a wavelength converter, which converts an input optical signal into an optical signal of a different wavelength to output the converted optical signal, and in particular, relates to an arrayed wavelength converter capable of performing wavelength conversion collectively on wavelengths of optical signals of a plurality of wavelengths.

(2) Description of the Related Art

As one technique for increasing transmission capacity of a communication using optical fibers, there is a wavelength division multiplexing (WDM) system. In an optical communication system to which the WDM system is applied, a plurality of optical carriers having different wavelengths is used. A plurality of optical signals obtained by independently modulating each optical carrier, is multiplexed by an optical multiplexer, and a WDM signal light obtained as a result, is sent out to an optical fiber transmission path. At a reception side, the received WDM signal light is separated into optical signals of respective wavelengths by an optical demultiplexer, and transmission data is regenerated based on the respective optical signals. Consequently, by applying the WDM system, the transmission capacity of one optical fiber can be increased according to the number of wavelength multiplexing times.

The future construction of a vast optical network (Photonic Network) where systems applied with the WDM systems are connected to each other, is being considered, and the development of node apparatus and optical cross-connection (OXC) apparatus needed for this construction is currently underway. The node apparatus is to be provided by an optical add/drop multiplexer (OADM), which performs dropping of optical signals from a network, and adding of optical signals into the network. The optical cross-connection apparatus is used for switching the routes of optical signals.

The direct connection of high-demand IP packet information to an optical network without using a contemporary SoneVSDH apparatus or an ATM apparatus is considered to become mainstream in the future (IP over WDM). Therefore, a wavelength converter, which converts the wavelengths of optical signals, is one of the technologies for realizing such an optical network.

As one of the technologies to convert the wavelengths of optical signals at high efficiency, which is indispensable for realizing such an optical network, a method is known (refer to Hiroshi Nishihara, Masamitsu Haruna, Toshiaki Suhara in collaboration, “Optical Integrated Circuit”, revised and enlarged edition, Ohmu Co., Dec. 25, 1994, p358-364; Japanese Unexamined Patent Publication No. 2003-66498 and Japanese Unexamined Patent Publication No. 2003-186070), wherein the wavelength conversion is performed using a polarization inversion structure formed within a ferroelectric crystal, in accordance with the quasi-phase matching (QPM) method. Specifically, as shown in FIG. 14 for example, a polarization inversion structure is formed in a ferroelectric crystal formed with an optical waveguide. In the polarization inversion structure, regions with a polarization direction of crystal being inverted and regions of original crystal where the polarization direction is not inversed, are arranged alternately at a previously set period. And, an optical signal incident on the waveguide, passes through the inversed regions and non-inversed regions, so that an optical signal whose wavelength is converted in accordance with the quasi-phase matching method, is generated.

The aforementioned quasi-phase matching method is a phase matching method performed using a polarization inversion structure. By changing the polarization inversion period, the wavelength of light after conversion can be changed. Therefore, it is possible to achieve high conversion efficiency. With the application of such a quasi-phase matching method, in the above described “Optical Integrated Circuit” by Nishihara et al., there is proposed an arbitrary wavelength conversion circuit performing the wavelength conversion with a wavelength band which includes one or a plurality of wavelength channels, as a unit. Moreover, in Japanese Unexamined Patent Publication No. 2003-186070, there is proposed an optical detector for detecting a light of a particular wavelength.

However, with the abovementioned wavelength conversion in accordance with the quasi-phase matching method using the polarization inversion structure, in the case where the wavelength conversion of optical signals of a plurality of wavelengths is performed using the polarization reversal structure with a single waveguide and a single period, it becomes difficult for all of the wavelengths to satisfy a phase matching condition expressed in the following equation (1). Therefore, there is a problem in that, for example as shown in FIG. 15, the output power after wavelength conversion becomes inconsistent among the wavelengths.

$$\frac{2 π m}{Λ} = {β}_{p} - {β}_{si} - {β}_{oi} \\ {ω}_{oi} = {ω}_{p} - {ω}_{si} \qquad ( 1 )$$

Here, Λ represents the period of the polarization inversion region, while βₛᵢ, βₒᵢ represent propagation constants of signal light and generated light corresponding to an ith wavelength, ωₛᵢ, ωₒᵢ represent frequencies, and ββₚ, ωₚ represent a propagation constant and a frequency of pumping light, respectively.

Note, in the wavelength conversion circuit disclosed in the above “Optical Integrated Circuit” by Nishihara et al., a plurality of wavelength conversion units corresponding to predetermined wavelength conversion are provided, and each of the wavelength conversion units is cascade connected, and an optical signal in a required wavelength band is converted to an optical signal in a different wavelength band. However, with such a wavelength conversion circuit, since the number of cascade connections of wavelength conversion units is increased and the number of components is increased, as the number of wavelengths of optical signals to be subjected to the wavelength conversion is increased, there is a disadvantage of expensive cost.

### SUMMARY OF THE INVENTION

The present invention has been accomplished in view of the above problems, and has an object to provide an arrayed wavelength converter with a simple structure, which enables highly efficient wavelength conversion, by either selecting optical signals of a plurality of wavelengths collectively, or selecting only an arbitrary wavelength.

To achieve the aforementioned object, an arrayed wavelength converter according to the present invention, which receives a plurality of optical signals of different wavelengths, and converts optical signals with two or more waves among the plurality of optical signals, into optical signals of other wavelengths, to output the converted optical signals, comprises a multiple wavelength conversion waveguide array including a plurality of waveguides formed in parallel on a substrate made of ferroelectric crystal, in which the optical signals with two or more waves are given to the plurality of waveguides, respectively, wherein the multiple wavelength conversion waveguide array has a periodic polarization structure formed by periodically providing polarization inversion regions where a polarization direction of the substrate is inversed, in a direction approximately perpendicular to a traveling direction of lights being propagated through the respective waveguides, and a period of the periodic polarization structure corresponding to each of the waveguides is made different for each waveguide.

With the arrayed wavelength converter of such a configuration, among the plurality of optical signals with different wavelengths, the optical signals with two or more waves are respectively given to the plurality of waveguides of the multiple wavelength conversion waveguide array, respectively, and alternately pass through the polarization inversion regions where the polarization direction of the substrate is reversed, and regions where the polarization direction of the substrate is not inversed, to be converted into optical signals of other wavelengths in accordance with the quasi-phase matching method.

Moreover, in the multiple wavelength conversion waveguide array, a ratio of the length of the polarization inversion region and the length of a non-polarization inversion region in the periodic polarization structure may be set to be approximately 1:1 in a longitudinal direction of the waveguides. As a result, wavelength conversion of the plurality of optical signals is performed with even higher efficiency.

Further, the above arrayed wavelength converter may comprise a demultiplexing section that receives a WDM signal light containing a plurality of optical signals of different wavelengths, and demultiplexes the WDM signal light according to wavelengths to output the demultiplexed lights, and in the multiple wavelength conversion waveguide array, a plurality of optical signals output from the demultiplexing section may be given to the respective waveguides. As a result, it becomes possible to collectively wavelength convert the optical signals of a plurality of wavelengths contained in the WDM signal light.

In addition, the above arrayed wavelength converter may comprise a pumping light supply section that supplies a pumping light to each of the waveguides of the multiple wavelength conversion waveguide array. Thus, the optical signals being propagated through the respective waveguides of the multiple wavelength conversion waveguide array, are wavelength converted in accordance with the quasi-phase matching method due to an effect of the pumping light.

Moreover, the above arrayed wavelength converter may comprise: a wavelength selecting section that receives a WDM signal light containing a plurality of optical signals of different wavelengths, and separates from the WDM signal light, a conversion light to be subjected to the wavelength conversion and a non-conversion light not to be subjected to the wavelength conversion, to output these lights; and a demultiplexing section that receives the conversion light from the wavelength selecting section, and demultiplexes the conversion light according to wavelengths, to output the demultiplexed lights, and in the multiple wavelength conversion waveguide array, the plurality of optical signals output from the demultiplexing section may be given to the respective waveguides. According to such a configuration, the wavelength conversion can be performed by selecting only optical signals of arbitrary wavelengths from the optical signals of the plurality of wavelengths contained in the input WDM signal light.

As described above, according to the arrayed wavelength converter of the present invention, it becomes possible to perform the wavelength conversion of a plurality of optical signals at high efficiency with a simple structure. Therefore, since an interchange of optical signals in different wavelength bands, such as a C-band and an L-band, can also be performed, it becomes possible to realize a highly functional optical cross-connection apparatus.

Other objects, feature, and advantages of the present invention will become apparent from following descriptions of the embodiments, in conjunction with the appended drawings.

### BRIEF DESCRIPTION OF THE DRAWING

FIG. 1 is a functional block diagram showing one embodiment of an arrayed wavelength converter of the present invention.

FIG. 2 is a perspective view showing a specific configuration example of a multiple wavelength conversion waveguide array of FIG. 1.

FIG. 3 is a diagram for explaining a relationship between the lengths of a polarization inversion region and a non-polarization inversion region, in the multiple wavelength conversion waveguide array of FIG. 2.

FIG. 4 is a diagram showing another configuration example of the multiple wavelength conversion waveguide array of FIG. 1.

FIG. 5 is a plan view showing a specific configuration example of the arrayed wavelength converter of FIG. 1, for the case where a WDM filter is used as a demultiplexing section.

FIG. 6 is a plan view showing a specific configuration example of the arrayed wavelength converter according to FIG. 1, for the case where an AWG is used as the demultiplexing section.

FIG. 7 is a diagram showing an output wavelength characteristic after wavelength conversion in the arrayed wavelength converter of FIG. 1.

FIG. 8 is a perspective view showing a modified example related to the arrayed wavelength converter of FIG. 1.

FIG. 9 is a block diagram showing another embodiment of the arrayed wavelength converter of the present invention.

FIG. 10 is a block diagram showing a further embodiment of the arrayed wavelength converter of the present invention.

FIG. 11 is a plan view showing a specific configuration example of the arrayed wavelength converter of FIG. 10.

FIG. 12 is a plan view showing another specific configuration example of the arrayed wavelength converter of FIG. 10.

FIG. 13 is a plan view showing a modified example related to the arrayed wavelength converter of FIG. 10.

FIG. 14 is a plan view showing one example of a wavelength converter according to a conventional quasi-phase matching method.

FIG. 15 is a diagram showing an output wavelength characteristic after wavelength conversion in the conventional wavelength converter.

### DETAILED DESCRIPTION OF THE INVENTION

Hereunder is a description of embodiments for implementing an arrayed wavelength converter of the present invention, with reference to the appended drawings. Throughout the drawings, the same reference numerals denote the same or equivalent parts.

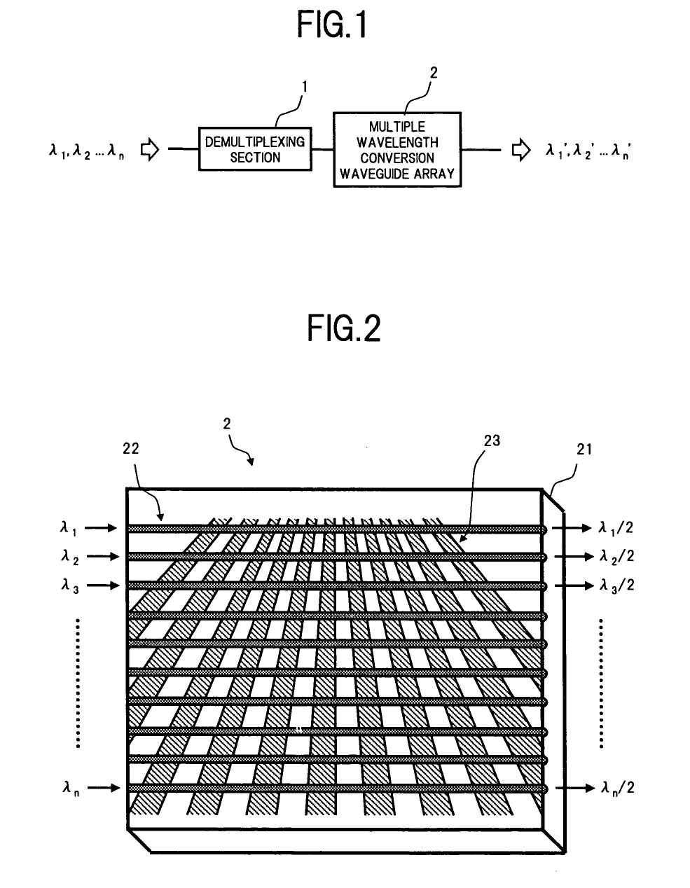

FIG. 1 is a functional block diagram showing a configuration of an arrayed wavelength converter according to one embodiment of the present invention.

In FIG. 1, the arrayed wavelength converter of the present embodiment comprises, for example, a demultiplexing section 1 to which a WDM signal light containing optical signals of a plurality of wavelengths, λ₁, λ₂ to λₙ, are input, and a multiple wavelength conversion waveguide array 2 to which is given optical signals of respective wavelength λ₁′, to λₙ′ output from the demultiplexing section 1.

The demultiplexing section 1 is for demultiplexing the input WDM signal light corresponding to wavelengths, to output demultiplexed lights, and can be constructed using a known element having a demultiplexing function, such as for example, a WDM filter or an arrayed waveguide grating (AWG).

In the multiple wavelength conversion waveguide array 2, as shown in a perspective view of FIG. 2, a plurality of waveguides 22 (here ‘n’) is formed in parallel on a ferroelectric substrate 21, and polarization inversion regions 23 are periodically formed in a direction substantially perpendicular to a traveling direction of a lights being propagated through each of the waveguides 22. On each of the polarization inversion region 23, an arrangement pattern is designed so that its period becomes a value appropriate for generating a second harmonic of the optical signal being propagated through each waveguide 22. By cascade connecting such a periodically poled on waveguide (PPWG) array device having a periodic polarization structure for multiple wavelengths, to the demultiplexing section 1, a highly efficient, broadband second harmonic generator (SHG) is constructed. Here, as a specific example of such a multiple wavelength conversion waveguide array 2, a periodically poled lithium niobate (PPLN) waveguide array is produced, by using a lithium niobate (LiNbO₃:LN) substrate for the ferroelectric substrate 21, and forming the waveguides 22 and the polarization inversion regions 23 with a known technique such as the proton exchange method or the like. However, the construction of the multiple wavelength conversion waveguide array 2 is not limited to the specific example described above, and it is also possible to use a lithium tantalate (LiTaO₃) substrate or a KTP crystal (KTiOPO₄) or the like, as the ferroelectric substrate 21. Further, a periodically poled MgO-doped lithium niobate (PPMgLN) crystal, which is durable against a photo-refractive damage, may be used as the ferroelectric substrate 21.

Here, a periodical polarization inversion structure of the multiple wavelength conversion waveguide array 2 will be described in detail.

In FIG. 2 described above, if a propagation constant for the optical signal being propagated through the waveguide 22 corresponding to the wavelength λᵢ (where i=1 to n) of the multiple wavelength conversion waveguide array 2 is β^{ω}ᵢ, and a propagation constant of the harmonic (output light) generated here is β^{2ω}ᵢ, a period Λᵢ of the polarization inversion structure for the waveguide 22 is designed so as to satisfy the following equation (2).

$${Λ}_{i} = \frac{2 π}{( {β}_{i}^{2 ω} - {β}_{i}^{ω} )} \qquad ( 2 )$$

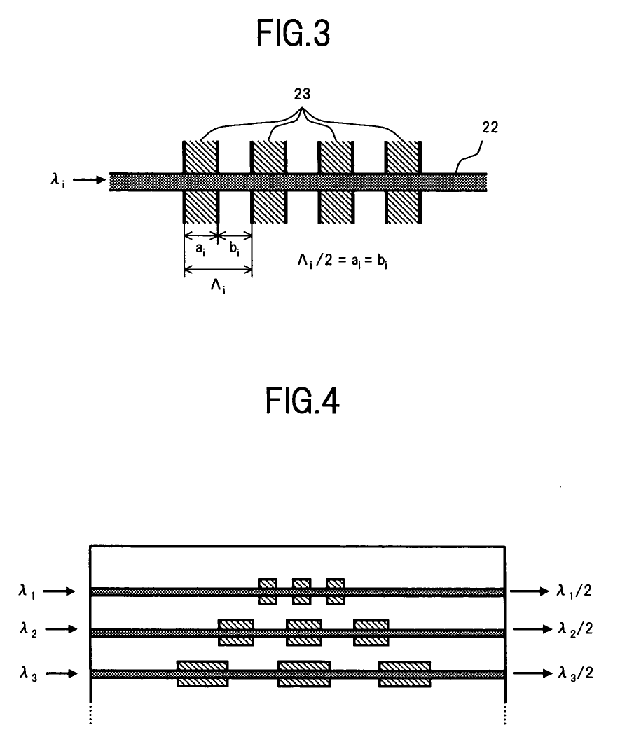

Further, it is known that the conversion efficiency of the harmonic is best when a ratio of the length of the polarization inversion region and the length of a non-polarization inversion region in a longitudinal direction of the waveguide is 1:1. Therefore, as shown in FIG. 3, when the length of the polarization inversion region on the waveguide 22 corresponding to the wavelength λᵢ of the multiple wavelength conversion waveguide array 2 is aᵢ, and the length of the non-polarization inversion region is bᵢ, it is desirable to design the form of the periodic arrangement pattern of the polarization inversion regions 23, so as to satisfy the following equation (3) for all the wavelengths λ₁ to λₙ.

$$\frac{{Λ}_{i}}{2} = {a}_{i} = {b}_{i} \qquad ( 3 )$$

Therefore, in the case where the wavelengths of the respective optical signals given from the demultiplexing section 1 to the respective waveguides 22 of the multiple wavelength conversion waveguide array 2 are sequentially arranged, it becomes possible to satisfy the abovementioned equations (2) and (3) for all the wavelengths λ₁ to λₙ, by making the periodic arrangement pattern of the polarization inversion regions 23 in a sector form (refer to FIG. 2).

The arrangement pattern of the polarization inversion regions 23 is not limited to the above described sector form. For example, as shown in FIG. 4, the polarization inversion region 23 may be formed in an arrangement pattern, which satisfies the equations (2) and (3) for each waveguide.

Next is a description of a specific configuration example of the embodiment of the arrayed wavelength converter described above.

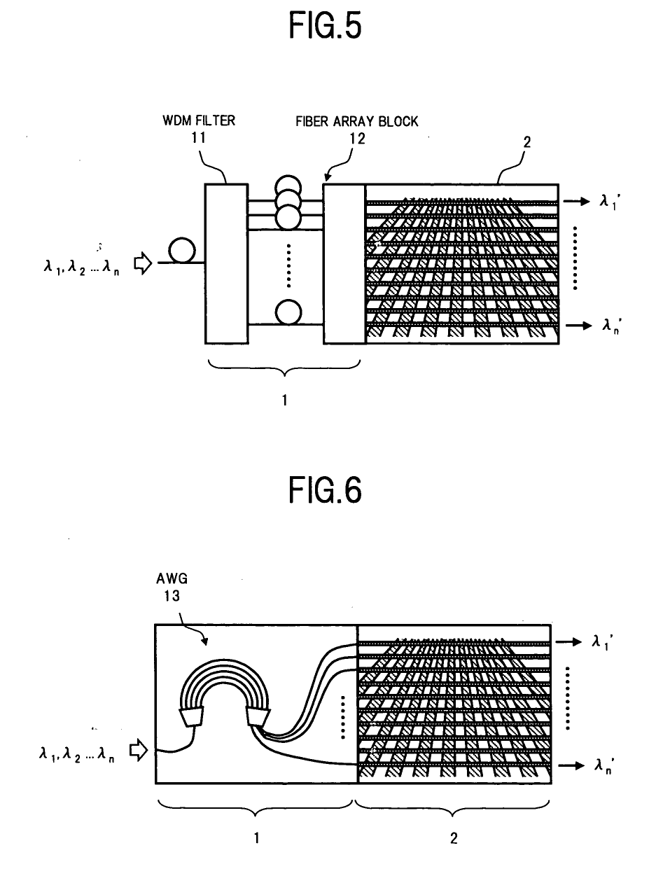

FIG. 5 is a plan view showing a specific configuration example for the case where the WDM filter is used as the demultiplexing section 1. In this configuration example, the WDM signal light to be input to the demultiplexing section 1, is demultiplexed into optical signals of respective wavelengths by the WDM filter 11, and then, sent to each of the waveguides of the multiple wavelength conversion waveguide array 2 via a fiber array block 12 connected by a butt-joint to the multiple wavelength conversion waveguide array 2. Here, although not shown in the figure, also for the output side of the multiple wavelength conversion waveguide array 2, it is possible to take out wavelength-converted optical signals by connecting a fiber array block to the multiple wavelength conversion waveguide array 2 in the same manner as for the input side.

FIG. 6 is a plan view showing a specific configuration example for the case where the AWG is used as the demultiplexing section 1. In this configuration example, the WDM signal light to be input to the demultiplexing section 1 is given to an input port of an AWG 13 which is directly connected to the multiple wavelength conversion waveguide array 2 (or is formed integrally with the multiple wavelength conversion waveguide array 2) to be demultiplexed, and then, the optical signals of each wavelength are sent to the respective waveguides 22 of the multiple wavelength conversion waveguide array 2. Such a configuration using the AWG 13 becomes simple compared to the configuration of FIG. 5. Hence, it becomes more effective, as the number of wavelengths of optical signals to be subjected to the wavelength conversion is increased.

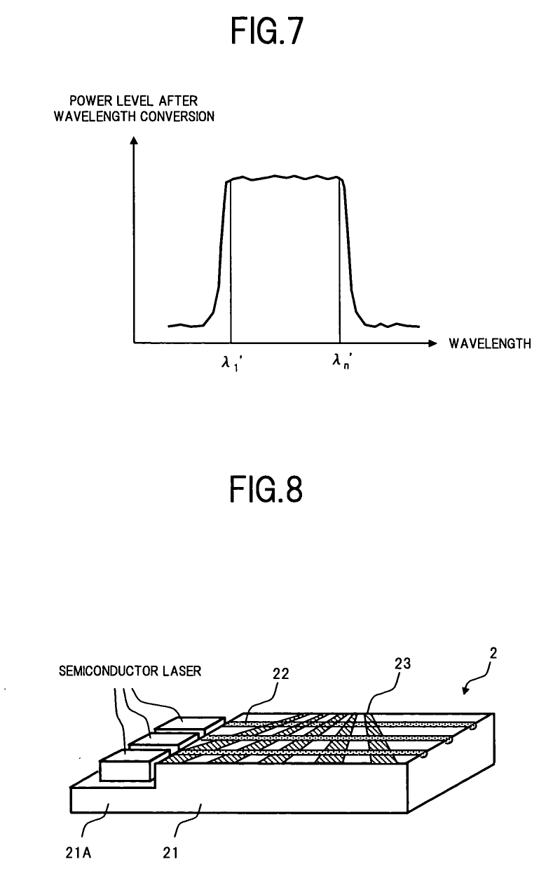

In the arrayed wavelength converter of the present embodiment provided with the above configuration, when the WDM signal light is input to the demultiplexing section 1, the respective optical signals demultiplexed according to the wavelengths are output from the demultiplexing section 1, to be given to the respective waveguides 22 of the multiple wavelength conversion waveguide array 2. In the multiple wavelength conversion waveguide array 2, the optical signals of respective wavelengths λ₁, to λₙ pass through the polarization inversion regions and the non-polarization inversion regions, alternately, so that second harmonics are generated, which are respectively converted into optical signals of wavelengths λ₁/2 to λₙ/2 to be output from the wavelength conversion waveguide array 2. More specifically, in the case where the WDM signal light in a 1500 nm band is input to the arrayed wavelength converter, the harmonics in a 750 nm band corresponding to the wavelengths of the respective optical signals contained in the WDM signal light are generated. The power of each optical signal after wavelength conversion, for example as shown in FIG. 7, becomes substantially uniform at the high level in terms of each wavelength.

As described, according to the present embodiment, it is possible to realize an arrayed wavelength converter, which enables the highly efficient and collective wavelength conversion of optical signals of a plurality of wavelengths, with an extremely simple structure. Since such an arrayed wavelength converter can be applied for example, to a wavelength band for optical communication, or visible light, or far-infrared having several μm wavelength, it can be utilized for wavelength conversion in optical apparatus for various types of applications.

Further, in the above embodiment, the description has been made on the configuration for the case where the WDM signal light containing optical signals of a plurality of wavelengths is input to the arrayed wavelength converter. However, as shown in a perspective view of FIG. 8, a modification can be made such that optical signals emitted from a plurality of semiconductor lasers with different wavelengths are incident on the multiple wavelength conversion waveguide array 2. In the configuration example of FIG. 8, a part of the substrate 21 of the multiple wavelength conversion waveguide array 2 is processed according to the size of a semiconductor laser chip, to provide a part 21A for mounting thereon the semiconductor laser, so that the optical signals from the respective semiconductor lasers are directly incident on the corresponding waveguides 22, or are incident through a lens or the like.

Next is a description of another embodiment of the arrayed wavelength converter of the present invention.

In the arrayed wavelength converter of the above described embodiment, the wavelength conversion of optical signals is performed by utilizing the generation of second harmonics in the multiple wavelength conversion waveguide arrays 2. However, the wavelength conversion using the multiple wavelength conversion waveguide array 2 is not limited to that utilizing the second harmonics, and it is also possible to utilize difference frequency generation (DFG), sum frequency generation (SFG) or optical parametric oscillation (OPO), as quasi-phase matching (QPM). Therefore, in the following embodiment, for example, the description is made on a configuration where suitable difference frequency generation is utilized as the wavelength converter for optical communication.

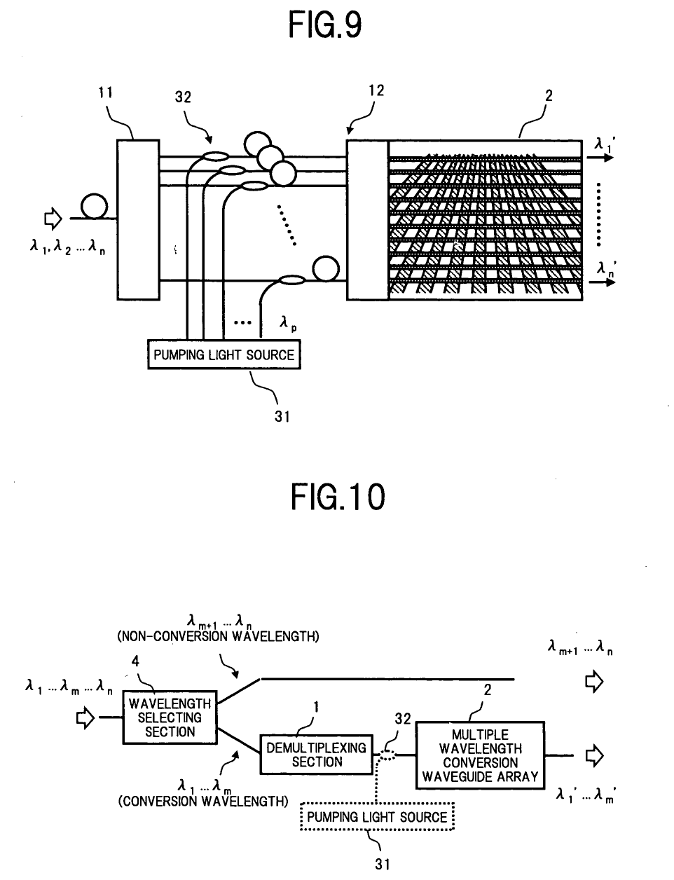

FIG. 9 is a plan view showing a configuration example of an arrayed wavelength converter utilizing the difference frequency generation.

The configuration example of FIG. 9 differs from the above described configuration example shown in FIG. 5 utilizing the second harmonic, in that there is provided optical couplers 32 and a pumping light source 31 serving as a pumping light supply section for supplying pumping lights to the waveguides 22 of the wavelength conversion waveguide array 2. The configuration other than the above is the same as the configuration shown in FIG. 5, and hence the description thereof is omitted here.

The pumping light source 31 is a typical light source generating a pumping light of a wavelength λₚ (frequency λₚ) as described later. The pumping light output from this pumping light source 31 is sent to each of the optical couplers 32 respectively inserted onto respective optical fibers of the fiber array block 12, which connects between output ports of the WDM filter 11 and the respective waveguides 22 of the multiple wavelength conversion waveguide array 2. In each optical coupler 32, the optical signal from the WDM filter 11 and the pumping light from the pumping light source 31 are multiplexed, to be sent to the waveguide 22 of the multiple wavelength conversion waveguide array 2.

Here is the description of a period Λᵢ of the polarization inversion structure in the multiple wavelength conversion waveguide array 2, and the wavelength λₚ (frequency ωₚ) of the pumping light, in the case of performing the wavelength conversion utilizing the difference frequency generation.

In the multiple wavelength conversion waveguide array 2, a phase matching condition for when performing the wavelength conversion utilizing the difference frequency generation can be expressed by the following equation (4), where the period of the polarization inversion region 23 in the waveguide 22 coresponding to the wavelength λᵢ is Λᵢ, and propagation constants and frequencies of the input light, pumping light and generated light (output light) propagated through the waveguide 22 are βᵢ, βₚᵢ, βₒᵢ, and ωₛᵢ, ωₚᵢ, ωₒᵢ, respectively.

$$\frac{2 π m}{{Λ}_{i}} = {β}_{pi} - {β}_{si} - {β}_{oi} \\ {ω}_{oi} = {ω}_{pi} - {ω}_{si} \qquad ( 4 )$$

Therefore, by designing the period A of the polarization inversion structure of the multiple wavelength conversion waveguide array 2, and the frequency ωₚᵢ of the pumping light to satisfy the abovementioned equation (4), collective wavelength conversion utilizing the difference frequency generation of the plurality of optical signals becomes possible. An example of specific design values is shown in the following Table 1.

TABLE 1

| i | λₛᵢ (μm) | λₒᵢ (μm) | λₚ (μm) | Λᵢ (μm) |
|---|---|---|---|---|
| 1 | 1.535 | 1.586 | 0.78 | 25.175 |
| 2 | 1.537 | 1.584 | 0.78 | 25.166 |
| 3 | 1.538 | 1.582 | 0.78 | 25.157 |
| 4 | 1.540 | 1.581 | 0.78 | 25.148 |
| 5 | 1.541 | 1.579 | 0.78 | 25.139 |
| 6 | 1.543 | 1.577 | 0.78 | 25.130 |
| 7 | 1.544 | 1.576 | 0.78 | 25.121 |
| 8 | 1.546 | 1.574 | 0.78 | 25.112 |

In the design example of Table 1, the pumping light wavelength of λₚ=0.78 μm is made common for all the respective wavelengths λₛᵢ (i=1 to 8) of the input light. Furthermore, the period Λᵢ of the polarization inversion structure is optimized, so that the generated light of a desired wavelength λₒᵢ can be obtained for each wavelength λₛᵢ of the input light in accordance with the above equation (4).

Moreover, the design example of the above Table 1 is for the case where the wavelength of the input light is converted to the longer wavelength side. However, in order to enable the wavelength conversion of the input light in an opposite direction, that is, to the shorter wavelength side, then as shown in the following Table 2, the pumping light wavelength λₚ and the period Λᵢ of the polarization inversion structure remain the same as in Table 1, and only the setting of the wavelength λₛᵢ of optical signals input to the respective waveguides 22 need be changed.

TABLE 2

| i | λₛᵢ (μm) | λₒᵢ (μm) | λₚ (μm) | Λᵢ (μm) |
|---|---|---|---|---|
| 1 | 1.574 | 1.546 | 0.78 | 25.175 |
| 2 | 1.576 | 1.544 | 0.78 | 25.166 |
| 3 | 1.577 | 1.543 | 0.78 | 25.157 |
| 4 | 1.579 | 1.541 | 0.78 | 25.148 |
| 5 | 1.581 | 1.540 | 0.78 | 25.139 |
| 6 | 1.582 | 1.538 | 0.78 | 25.130 |
| 7 | 1.584 | 1.537 | 0.78 | 25.121 |
| 8 | 1.586 | 1.535 | 0.78 | 25.112 |

According to the arrayed wavelength converter utilizing the difference frequency generation in this manner, by applying the design values of the above Table 1 and Table 2, for example, it becomes possible to perform mutual wavelength conversion between the C-band and the L-band in optical communication, with approximately the same efficiency.

Furthermore, in the above embodiment, the description has been made on the case where the difference frequency generation is utilized as the alternative configuration example for the arrayed wavelength converter utilizing the second harmonic generation. Similarly, it is also possible to configure an arrayed wavelength converter utilizing the sum-frequency generation or the optical-parametric-oscillation. More specifically, in the case of performing the wavelength conversion utilizing the sum-frequency generation, the period Λᵢ of the polarization inversion structure and the frequency ωₚᵢ of the pumping light need only be designed to satisfy the phase matching condition represented in the following equation (5), instead of the equation (4).

$$\frac{2 π m}{{Λ}_{i}} = - {β}_{pi} - {β}_{si} + {β}_{oi} \\ {ω}_{oi} = {ω}_{pi} + {ω}_{si} \qquad ( 5 )$$

Moreover, to give a simple description of the wavelength conversion utilizing the optical-parametric-oscillation, when an input light with a frequency ωₛ and a pumping light with a frequency ωₚ are given to the waveguide having the polarization inversion structure, a light of frequency ωₒ, which satisfies the relationship ωₒ=ωₛ−ωₚ, is generated, and by mean of this generated light with frequency ωₒ and the pumping light with frequency ωₚ, an optical signal with a frequency ωₛ is amplified (optical parametric amplification). By placing this optical signal into a Fabri-Perot resonator, optical signals with frequencies ωₛ, ωₒ oscillate (optical parametric oscillation). As an application of such optical parametric oscillation, the multiple wavelength conversion waveguide array 2 is arranged in the Fabri-Perot resonator to be used, the wavelength conversion of optical signals of a plurality of wavelengths becomes possible.

Next is a description of a further embodiment of the arrayed wavelength converter of the present invention.

In each of the above described embodiments, the configuration has been shown where all of the wavelengths of multiple input optical signals are converted collectively. However, in an optical cross-connection (OXC) apparatus for example, there is the case where only optical signals of arbitrary wavelengths need to be selected for wavelength conversion, from optical signals of a plurality of wavelengths contained in the input WDM signal light. Therefore, in the following embodiment, the description is made on one example of an arrayed wavelength converter corresponding to such a case.

FIG. 10 is a functional block diagram showing a configuration example of the arrayed wavelength converter of the present invention, capable of selecting optical signals of arbitrary wavelengths.

The arrayed wavelength converter shown in FIG. 10 is such that, in the configuration shown in FIG. 1, a wavelength selecting section 4 is provided on the former stage of the demultiplexing section 1, and in the wavelength selecting section 4, optical signals of a plurality of wavelengths contained in the input WDM signal light are separated into optical signals to be subjected to the wavelength conversion (conversion light) and optical signals not to be subjected to the wavelength conversion (non-conversion light), and the conversion light is sent from one output port of the wavelength selecting section to the demultiplexing section 1, while the non-conversion light is sent to the other output port.

Here, the configurations of the demultiplexing section 1 and the multiple wavelength conversion waveguide array 2 are the same as for the case of the above respective embodiments. That is to say, the configuration shown with solid lines in FIG. 10 corresponds to the wavelength conversion utilizing the second harmonic generation, which is added with the configuration shown with broken lines to correspond to the wavelength conversion utilizing the difference frequency generation.

In the wavelength selecting section 4, information relating to the optical signals to be subjected to the wavelength conversion is either previously set or supplied from the outside, and in accordance with this information, the optical signals to be subjected to the wavelength conversion are selected from the optical signals of a plurality of wavelengths contained in the WDM signal light given to an input port of the wavelength selecting section 4. Then, at the same time as outputting conversion light from one of output ports connected to the latter stage demultiplexing section 1, non-conversion light is output from the other output port. Here, one example is shown for where, among the wavelengths λ₁ to λₘ, and λₘ₊₁ to λₙ contained in the WDM signal light, the wavelengths λ₁ to λₘ are made the conversion light and the wavelengths λₘ₊₁ to λₙ are made the non-conversion light. Here, the wavelength of the optical signal to be selected in the wavelength selecting section 4 can either be fixed or variable. As a specific example of the wavelength selecting section 4 in which the wavelength to be selected is variable, an acousto-optic tunable filter (AOTF) or the like is suitable.

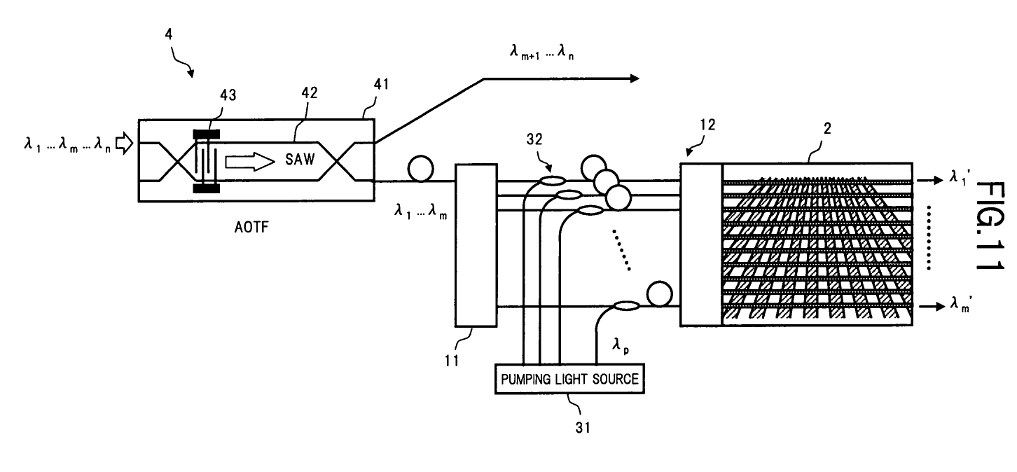

FIG. 11 is a plan view showing a specific configuration example for the case where an AOTF is adopted as the wavelength selecting section 4 and the difference frequency generation is utilized in the multiple wavelength conversion waveguide array 2, to perform the wavelength conversion. In the configuration example of FIG. 11, the wavelength selecting section 4 using the AOTF includes, for example, a Mach-Zehnder type waveguide 42 and an interdigital transducer (IDT) 43 on an LN substrate 41. In this AOTF, a surface acoustic wave (SAW), which is generated by applying to the inter-digital transducer 43, RF signals with frequencies corresponding to the wavelengths λ₁ to λₘ of the optical signals to be subjected to the wavelength conversion, travels along the waveguide 42, and based on an acousto-optical effect due to this SAW, the optical signals of the wavelengths λ₁ to λₘ are simultaneously taken out from one of output ports. Then, the optical signals of the wavelengths λ₁ to λₘ sent from the AOTF to the demultiplexing section 1, as with the above configuration shown in FIG. 9, are demultiplexed by the demultiplexing section 1 into the respective wavelengths and then given to the respective waveguides of the multiple wavelength conversion waveguide array 2, to be wavelength converted.

As described above, according to the arrayed wavelength converter of the present embodiment, only arbitrary wavelengths are selected from the optical signals of a plurality of wavelengths to be input, and hence, the wavelength conversion can be performed with high efficiency. By using such an arrayed wavelength converter, it is possible to easily realize an optical cross-connection apparatus (OXC) or the like.

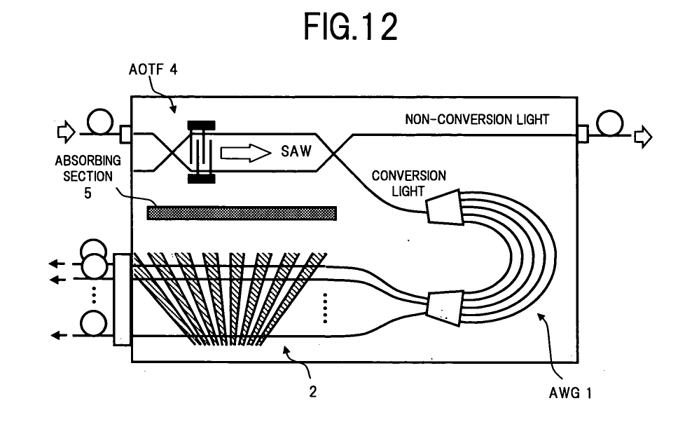

In the configuration example of FIG. 11, the case has been shown where the WDM filter 11 and the fiber array block 12 are used as the demultiplexing section 1. However, as shown in FIG. 6, it is also possible to use the AWG as the demultiplexing section 1. In the case of using the AWG as the demultiplexing section 1, then for example as shown in FIG. 12, it is also possible to integrate the AOTF being the wavelength selecting section 4, the AWG being the demultiplexing section 1, and the multiple wavelength conversion waveguide array 2 onto the same LN substrate. Note, an absorption section 5 provided between the AOTF and the multiple wavelength conversion waveguide array 2 is for absorbing the SAW generated by the AOTF, to prevent the SAW from being transmitted to the side of the multiple wavelength conversion waveguide array 2. By applying such an integrated configuration, miniaturization and cost reduction of the arrayed wavelength converter becomes possible.

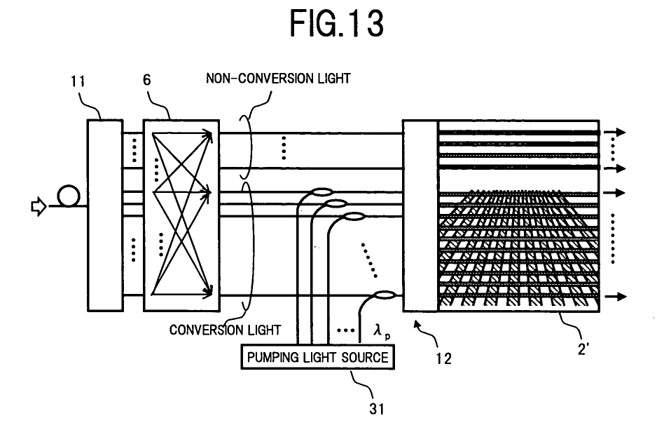

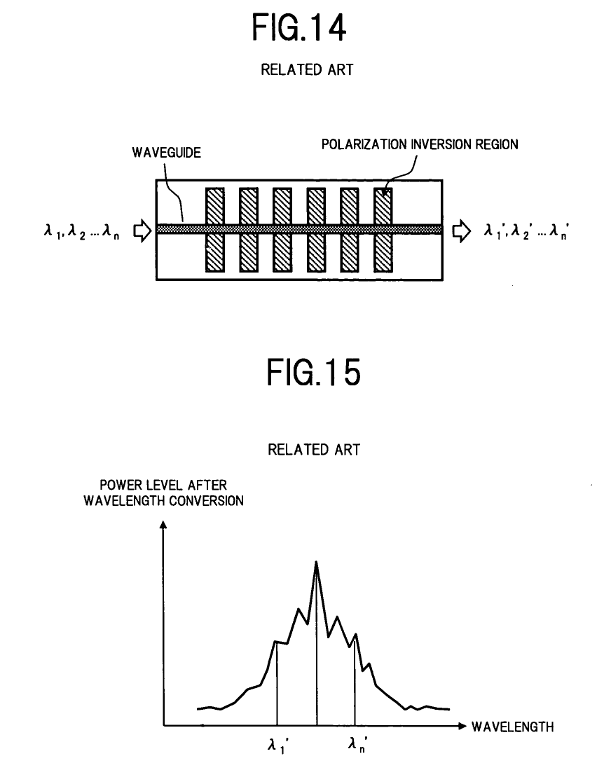

Furthermore, in the above embodiment, a specific example using the AOTF as the wavelength selecting section 4 has been shown. However, the wavelength selecting section of the present invention is not limited to the AOTF, and for example as shown in FIG. 13, it is also possible to perform the selection of the conversion light and the non-conversion light utilizing an optical switch 6. In this example of FIG. 13, an n×n optical switch 6 corresponding to the optical signals of the wavelength λ₁ to λₘ contained in the WDM signal light, is inserted between the WDM filter 11 and the multiple wavelength conversion waveguide array 2, and by switching the connection condition of the input/output ports by this optical switch 6, the selection of the conversion light and of the non-conversion light is performed. For this n×n optical switch 6, it is possible to use, for example, an optical switch using a so-called MEMS mirror, manufactured by the application of micro machining (Micro Electric Mechanical System: MEMS) technology. Moreover here, the waveguides for the non-conversion lights are formed on a part of the multiple wavelength conversion waveguide array 2 (the polarization inversion region is not formed), and the non-conversion lights output from the optical switch 6 are given to these non-conversion light waveguides via the fiber array block 12. Also with the configuration using such an optical switch 6, it is possible to perform the wavelength conversion with high efficiency, by selecting only arbitrary wavelengths from the input optical signals of a plurality of wavelengths.

1. An arrayed wavelength converter which receives a plurality of optical signals of different wavelengths, and converts optical signals with two or more waves among said plurality of optical signals, into optical signals of other wavelengths, to output the converted optical signals, comprising;
a multiple wavelength conversion waveguide array including a plurality of waveguides formed in parallel on a substrate made of ferroelectric crystal, in which said optical signals with two or more waves are given to said plurality of waveguides, respectively,
wherein said multiple wavelength conversion waveguide array has a periodic polarization structure formed by periodically providing polarization inversion regions where a polarization direction of said substrate is inversed, in a direction approximately perpendicular to a traveling direction of lights being propagated through the respective waveguides, and a period of said periodic polarization structure corresponding to each of the waveguides is made different for each waveguide.

2. An arrayed wavelength converter according to claim 1,
wherein in said multiple wavelength conversion waveguide array, a ratio of the length of the polarization inversion region and the length of a non-polarization inversion region in the periodic polarization structure is set to be approximately 1:1, in a longitudinal direction of said respective waveguides.

3. An arrayed wavelength converter according to claim 1,
wherein in said multiple wavelength conversion waveguide array, periods corresponding to the respective waveguides of said periodic polarization structure are set in accordance with phase matching conditions for second harmonic generation of the optical signal being propagated through each waveguide.

4. An arrayed wavelength converter according to claim 1, further comprising;
a demultiplexing section that receives a WDM signal light containing a plurality of optical signals of different wavelengths, and demultiplexes said WDM signal light according to wavelengths, to output the demultiplexed lights,
wherein in the multiple wavelength conversion waveguide array, a plurality of optical signals output from said demultiplexing section is given to the respective waveguides.

5. An arrayed wavelength converter according to claim 4,
wherein said demultiplexing section includes a WDM filter.

6. An arrayed wavelength converter according to claim 4,
wherein said demultiplexing section includes an arrayed waveguide grating (AWG).

7. An arrayed wavelength converter according to claim 1, further comprising;
a plurality of light sources outputting optical signals of different wavelengths,
wherein in said multiple wavelength conversion waveguide array, the optical signals output form said plurality of light sources are given to said respective waveguides.

8. An arrayed wavelength converter according to claim 1, further comprising;
a pumping light supply section that supplies a pumping light to each waveguide of said multiple wavelength conversion waveguide array.

9. An arrayed wavelength converter according to claim 8,
wherein in said multiple wavelength conversion waveguide array, periods corresponding to the respective waveguides of said periodic polarization structure are set in accordance with phase matching conditions for difference frequency generation of the optical signal and pumping light being propagated through each waveguide.

10. An arrayed wavelength converter according to claim 8,
wherein in said multiple wavelength conversion waveguide array, periods corresponding to the respective waveguides of said periodic polarization structure are set in accordance with phase matching conditions for sum-frequency generation of the optical signal and pumping light being propagated through each waveguide.

11. An arrayed wavelength converter according to claim 8,
wherein in said multiple wavelength conversion waveguide array, periods corresponding to the respective waveguides of said periodic polarization structure are set in accordance with phase matching conditions for optical parametric oscillation of the optical signal and pumping light being propagated through each waveguide.

12. An arrayed wavelength converter according to claim 1, further comprising:
a wavelength selecting section that receives a WDM signal light containing a plurality of optical signals of different wavelengths, and separates from said WDM signal light, a conversion light to be subjected to the wavelength conversion and a non-conversion light not to be subjected to the wavelength conversion, to output these lights; and
a demultiplexing section that receives the conversion light from said wavelength selecting section, and demultiplexes said conversion light according to wavelengths, to output the demultiplexed lights,
wherein in the multiple wavelength conversion waveguide array, the plurality of optical signals output from said demultiplexing section is given to said respective waveguides.

13. An arrayed wavelength converter according to claim 12,
wherein said wavelength selecting section includes an acousto-optic tunable filter.

14. An arrayed wavelength converter according to claim 12,
wherein said demultiplexing section includes a WDM filter.

15. An arrayed wavelength converter according to claim 12,
wherein said demultiplexing section includes an arrayed waveguide grating (AWG).

16. An arrayed wavelength converter according to claim 12,
wherein said wavelength selecting section comprising an acousto-optic tunable filter, said demultiplexing section comprising an arrayed waveguide grating (AWG), and said multiple wavelength conversion waveguide array are integrated onto the same substrate.

17. An arrayed wavelength converter according to claim 1, further comprising:
a demultiplexing section that receives a WDM signal light containing a plurality of optical signals of different wavelengths, and demultiplexes said WDM signal light corresponding to wavelengths, to output the demultiplexed lights; and
an optical switch which receives a plurality of optical signals from said demultiplexing section at a plurality of input ports thereof, and connects the input port to which is given the optical signals to be subjected to the wavelength conversion, to a conversion side output port thereof, and connects the input port to which is given the optical signals not to be subjected to the wavelength conversion, to a non-conversion side output port thereof,
wherein in said multiple wavelength conversion waveguide array, the plurality of optical signals output from the conversion side output port of said optical switch are given to said respective waveguides.

18. An arrayed wavelength converter according to claim 1,
wherein said multiple wavelength conversion waveguide array is constructed using a lithium niobate substrate.

19. An arrayed wavelength converter according to claim 1,
wherein said multiple wavelength conversion waveguide array is constructed using any one of a lithium tantalate, a KTP crystal, and a magnesium oxide doped lithium niobate for the substrate material.
